(19) United States
(12) Patent Application Publication
(10) Pub. No.: US 2003/0184028 A1
(43) Pub. Date: Oct. 2, 2003

(54) True fit collet method and apparatus

(76) Inventor: J. C. Schlotterer, Carson City, NV (US)

Correspondence Address: Herbert C. Schulze, 2790 Wrondel Way, PMB36, Reno, NV, 89502, US

(21) Appl. No.: 10/114,692

(22) Filed: Apr. 1, 2002

(51) Int. Cl. B23B 31/20

(52) U.S. Cl. 279/51

(57) ABSTRACT

This invention comprises improved collets which can be used and reused without adjustment or re-truing by the use of truncated spherical and tangential mating surfaces, elliptical mating elements, dowel and keyway alignment means, tension and travel limiting means to prevent binding and over expansion or contraction of collet head elements, and the like to achieve true fitting and secure adjustment of collets and their mating and interacting parts.

### BACKGROUND OF THE INVENTION

I. Field of the Invention

This invention is in the general field of machine tools and accessories;

The invention is more particularly in the field of devices and methods for holding work pieces in lathes, milling machines and the like during machining operations;

The invention is most particularly in the field of collets with the ability to remain true and accurate and with the characteristic of being repetitively used without necessity of corrective truing adjustment between uses.

II. Description of the Prior Art

Those skilled in the art are familiar with collets and their functions and uses. However, for those who are interested, but may be unfamiliar with the term, a collet is a device for holding a machining tool or a work piece (an item being machined) in connection with lathes, milling machines, and the like. Collets are of two types, internal and external. My present invention embodies certain principles and elements which are the subject of this invention and which apply to both internal and external collets. In precision machining and the like collets are preferred to chucks and other holding devices as they are more precise and they grip a tool or workpiece more securely and retain the grip over a longer period of time. This is due to the manner in which collets grip the tools and workpieces by positive pressure of tapered collars, pull screws, shoulders and the like. This is known to those skilled in the art. These very features, however make the use of collets time consuming and expensive. Particularly, it is generally necessary to adjust the collets between uses. Also, the collets may have a tendency to bind on inclined surfaces and the like which are used in achieving proper gripping of tools and work pieces.

There has been much prior art in the field of collets and the like. This is a crowded field because of the cost of machining and the necessity of accuracy which must frequently be held to extremely small tolerances, as is known to those skilled in the art.

I have been engaged in precision machining for many years and I am familiar with machine tools and accessories as well as texts and other literature and virtually all machining techniques and practices. Additionally I have examined patent files and the like. I have found that there are many patents concerning collets and the like. I have also found that in this field advances and improvements are generally accomplished in small increments.

A good example of the importance and the crowded state of the art can be understood by reviewing recently issued U.S. Pat. No. 6,350,087 and the large number of references cited. This particular patent is not related to my inventions and does not anticipate nor suggest my invention. It is merely mentioned as a matter of showing the large amount of prior collet art and the importance of the field.

In all of my experience and research I have not discovered prior art which would anticipate nor suggest the combinations and methods I have conceived and developed which are disclosed herein.

My present invention involves a combination of the use of spherical, elliptical, and other specially shaped segments which combine in such manner as to allow for many advantages including the ability to use one collet repeatedly for a specific work piece or tool without any requirement for adjusting and truing between repeated uses.

### SUMMARY OF THE INVENTION

My invention involves a method for making collets as well as the collets themselves in which I provide combinations of cooperative and complimentary procedures and elements to produce Specially selected shaped and mating elements in collets resulting in the unexpected superior performance as described herein.

Among others, my methods result in innovative uses of geometric shapes which cooperate to result in collets of superior accuracy, durability and longevity while at the same time reducing the time for change from one machining task to another. I accomplish this by utilizing special truncated spherical, elliptical and the like shapes and elements on collet elements in order assure that mating and interacting parts of a completed collet assembly will continue to be true on repeated uses of the same collet without the necessity of adjusting and truing between uses as has been generally the situation prior to my present invention.

Some specific items I provide or shape in a unique, novel and useful manner are: pull screw heads and the like which are in the form of truncated spheres providing tangential contact which eliminates the binding of pull screw heads and collet heads which occurs with customary non-tangential contact; elliptical male and female mating elements such as between spindle and closer elements; travel stop and stop washers which limit the travel of pull screws preventing over expansion or contraction of the collet; springs to enable the pull screws to move away and allow collets to collapse; dowel pins and keyways to provide accurate alignment and prevent rotation between different elements; slip fits between male and female mating parts.

For tangential contact with collet head surfaces I have found that the truncated spherical shape is most desirable. However, other shapes resulting in tangential contact could be used. Likewise, shapes other than elliptical between mating male and female elements might be used, although I believe the elliptical to be best. Travel might possibly be limited in certain other ways, however I believe the manner I have indicated to be the most preferable. Alignment by the dowels and keyways I have used is unique, novel and useful. However, certain equivalents might be used without departing from the inventive concepts disclosed.

It is an object of this invention to provide a unique, novel and useful method for manufacture of collets;

Another object of this invention is to provide such a method wherein a unique, novel and useful combination of geometric shapes on various parts of a collet resulting in superior performance;

Another object of this invention is to provide unique, novel and useful collets which reduce machining time in preparation and treatment of work pieces;

Another object of this invention is to enhance the usefulness of machine tools and accessories;

Another object of this invention is to provide a method for decreasing the setup time required in using collets;

Another object of this invention is to provide enhanced collets which result in more precise machining of work pieces.

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a perspective of a preferred embodiment of an internal collet made by, embodying the principles of, and suitable to practice, the methods of this invention;

FIG. 1A is an enlarged broken section of a portion of a pull screw head within, and against a surface of a collet head segment of the collet of FIG. 1;

FIG. 2 is an exploded view of the collet of FIG. 1;

FIG. 3 is an enlarged exploded perspective of selected elements of the embodiment of FIG. 1;

FIG. 4 is an enlarged exploded perspective of selected elements of the embodiment of FIG. 1;

FIG. 5 is a perspective of a preferred embodiment of an external collet made by, embodying the principles of, and suitable to practice, the methods of this invention;

FIG. 5A is an enlarged broken section of a portion of an external collet head segment within, and against an inner surface of a collet body; and

FIG. 6 is an exploded view of the collet of FIG. 5.

### DESCRIPTION OF A PREFERRED EMBODIMENT

Definition: In referring to collets there is sometimes confusion as to the meaning of the terms “internal collet” and “external collet”. (1) Some persons may use to term “internal collet” to mean that an interior of a tool or workpiece will be gripped by an exterior of the collet, and the term “external collet” to mean that an exterior of a tool or workpiece will be gripped by an interior of the collet, while (2) others may use the term “internal collet” to mean that an interior of the collet will grip an exterior of the tool or workpiece, and the term “exterior collet” to mean that an exterior of the collet will grip an interior of the tool or workpiece. Throughout this application for patent I use definition (1),

An inventory of items in the drawings with reference numerals is:

| Numeral | Item |
|---|---|
| 10 | internal collet assembly generally |
| 11 | spindle |
| 12 | straight shank |
| 13 | keyway |
| 14 | taper |
| 15 | collar |
| 16 | flange |
| 17 | washer |
| 18 | spring |
| 20 | closer |
| 21 | elliptical boss |
| 22 | threads |
| 23 | spring pin hole |
| 24 | collet nut |
| 25 | spring pin |
| 26 | elliptical hole |
| 30 | travel stop |
| 31 | shank |
| 32 | hole |
| 33 | shoulder |
| 34 | shoulder |
| 35 | enlarged portion |
| 36 | collar |
| 40 | collet head |
| 41 | collet segment |
| 42 | slots between segments |
| 43 | pull screw |
| 44 | threads |
| 45 | keyway |
| 46 | dowel pin |
| 47 | pull screw head |
| 50 | external collet generally |
| 51 | assembly |
| 52 | spindle |
| 53 | body |
| 54 | dowel pin hole |
| 55 | spring |
| 56 | pull screw |
| 57 | collet head |
| 58 | elliptical closer boss |
| 59 | truncated spherical bearing surface |
| 60 | collar bearing edge |
| 61 | elliptical hole |
| 62 | retainer ring |
| 63 | dowel |
| 64 | keyway |

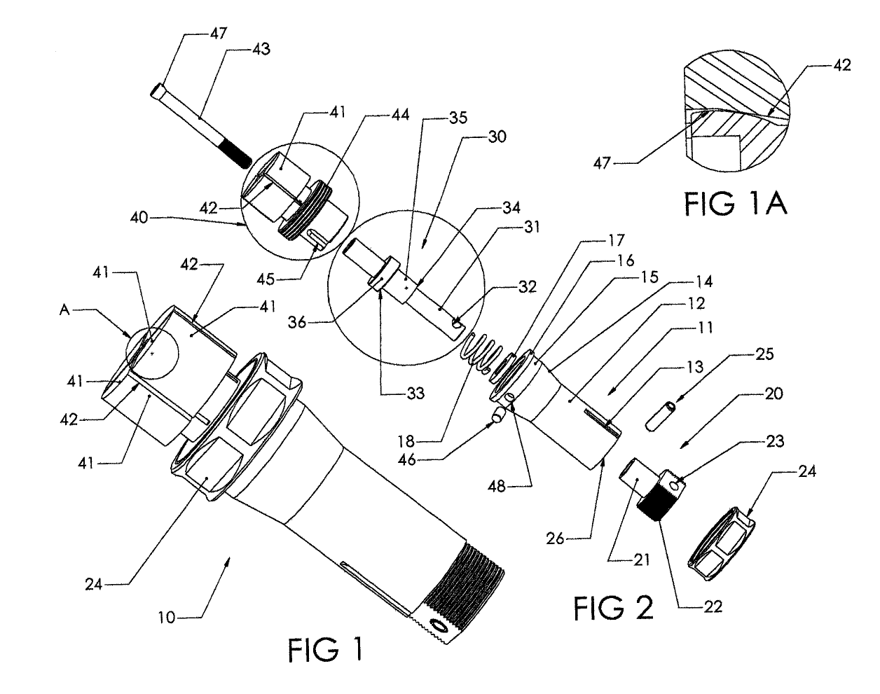

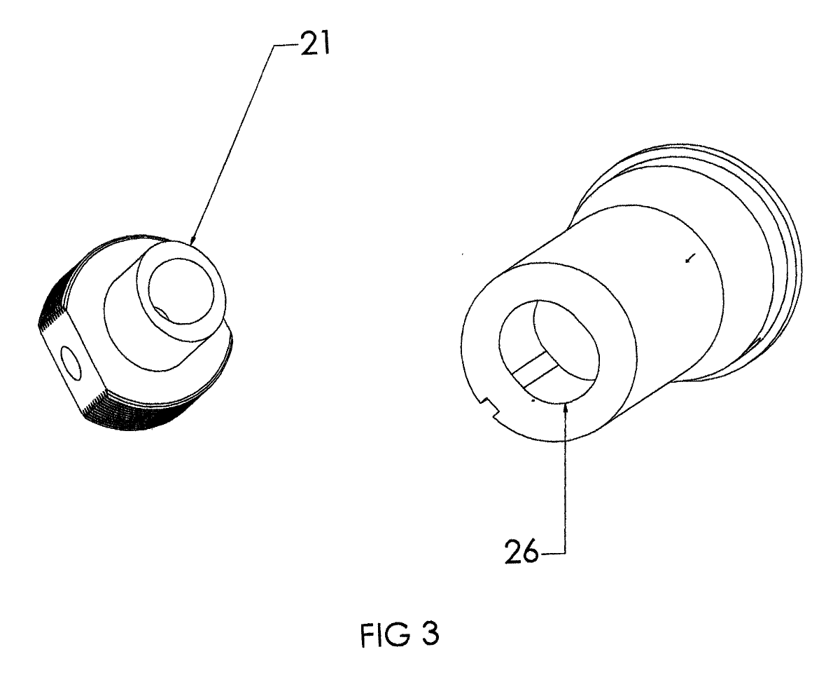

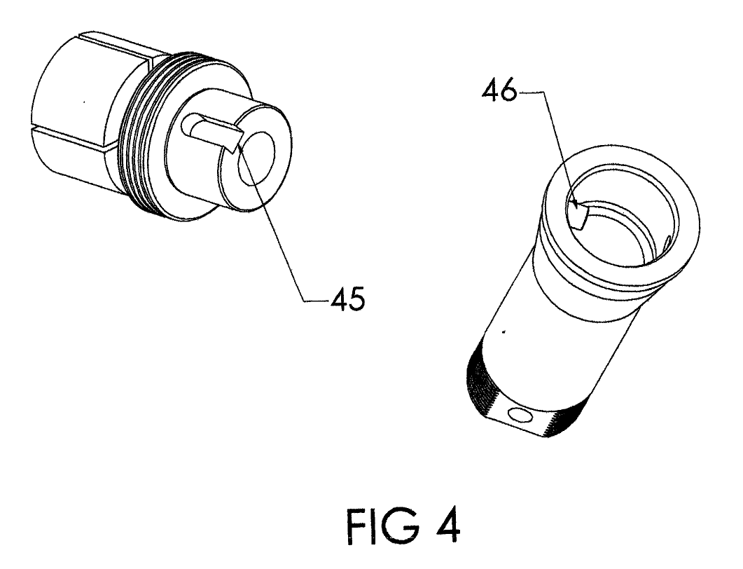

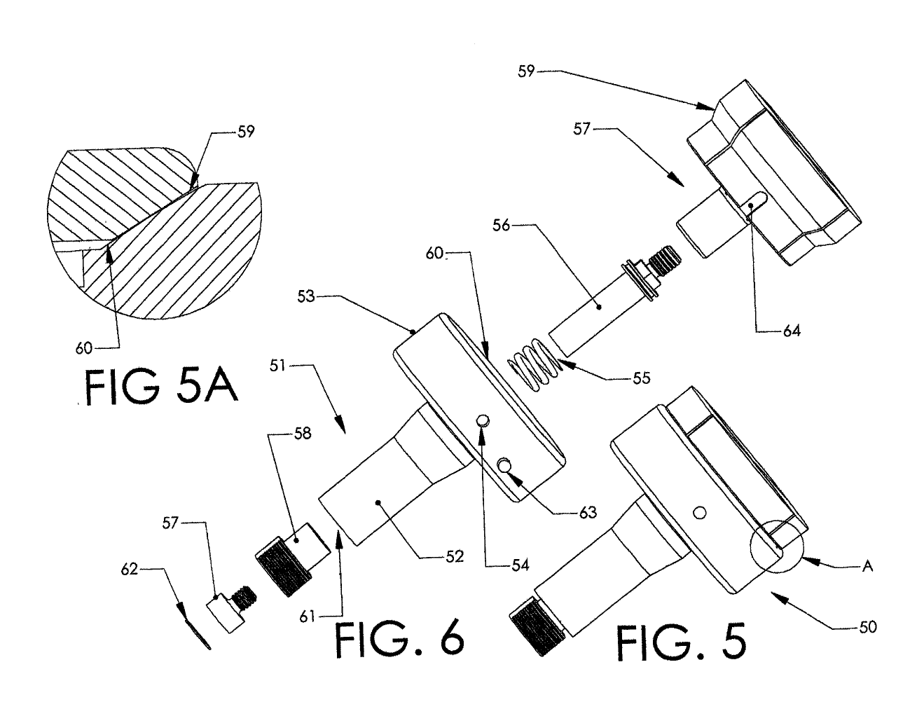

FIGS. 1, 2, 3, and 4 should be viewed together. They show an internal collet 10 made of any suitable material composed of a spindle, or body 11 having a shank 12 with keyway 13, collar 15, intermediate taper 14, a collar 15, and flange 16. On the interior there will be a stop washer 17 and spring 18. Travel stop 30 consists of shank 31 which has an enlarged portion 35 with shoulders 33 and 34 and a further enlarged collar 36. A hole 32 accommodates spring pin 25 through spring pin hole 23 in threaded 22 closer 20. Spindle 11 has an elliptical hole 26 to mate with elliptical boss 21. Keyway 45 and dowel pin 46 assure repeated uses and dismantling with complete accuracy. The collet nut 24 has internal threads which engage threads 44 on the collet head 40 as will be understood by those skilled in the art.

These are important advances in the art and assists maintaining the true fit of the parts.

The pull screw 43 is threaded into travel stop 30. The pull screw head 47 is uniquely shaped as a truncated sphere. This has the unexpected result of eliminating binding between the pull screw head 47 and the inclined inner surfaces of slots 42 between the collet head segments 41 which has frequently been a cause of problems with the alignment and truing of collets'

An external collet 50 made of any suitable material is composed of assembly 51 including spindle 52, collet head 57 having a new, unique, and useful sliding bearing surface 59. In the past it has always been routine in the art to form this bearing surface at a ten degree angle to the collet axis. This ten degree angle has the effect that a deviation of one measurement unit in the diameter of a workpiece or tool being held by the collet will cause a deviation of three measurement units in the axis. I have discovered that by forming the bearing surface 59 at a thirty degree angle to the axis that a change in the diametric measurement unit does not affect the axis measurement. I have also discovered that by making the bearing surface 59 in the shape of a truncated sphere the unexpected result is that the bearing edge 60 of the body 53 and the bearing surface 59 do not have a tendency to bind which is frequently encountered with external collets. If this truncated spherical surface is on a very large diameter with the thirty degree angle measured across the beginning and ending of the bearing surface 59 the integrity of the axis is preserved on diametric variations occurring. Thus, the accuracy of the true fit of this collet on repeated uses is further enhanced.

This external collet elliptical closer boss 58 will mate with elliptical hole 61 in spindle 52 (not visible but understood by those skilled in the art and similar in appearance and function to the elliptical hole 26 in spindle 11 of the internal collet shown in FIG. 3). Dowel 63 mating with keyway 64 is another feature of this collet. This will insure accuracy of alignment in the exterior collet as previously described for the interior collet 10. As will be understood by those skilled in the art retainer ring 62 completes the assembly.

The novel, unique and useful features of my new collet inventions have been set forth in the foregoing description and in the claims which follow, which claims are incorporated in this description of a preferred embodiment by this reference.

While the embodiments shown and described are fully capable of achieving the objects and advantages desired, it is to be understood that such embodiments have been shown for purposes of demonstration only and not for purposes of limitation.

In the claims which follow if I should fail to claim any patentable feature such failure to claim will be inadvertent and is not to be interpreted as an abandonment or dedication of such feature. In such event, upon discovering the failure to claim 1 shall immediately seek to correct it by any proper means.

I claim:

1. An improved true fit collet comprising: an otherwise customary collet assembly in which mating collet portions include at least one truncated spherical bearing surface.

2. An improved true fit collet comprising: an otherwise customary collet assembly in which mating collet portions include at least one helical shaped element.

3. A method of manufacturing collets comprising: an otherwise customary collet manufacturing method in which at least one pull screw is specially shaped to create a tangent contact with a mating surface.

4. A method of manufacturing collets which includes the formation of at least one truncated spherical element.

5. A method of manufacturing collets which includes specially shaping of at least one surface of at least one element of the collet in such manner that it will create a tangential contact with another surface of the collet when assembled and in use.

6. The improvement in a collet of means cooperative with a collet pull screw to prevent excessive movement of the pull screw in order to avoid over expansion of the collet.

7. A collet having a slip fit between the outside of a collet head and the interior of a collet body.

8. The method of assuring alignment between a collet head and a collet body comprising: providing a dowel pin on the interior of a female element and an interacting keyway on the exterior of a mating male element.

9. A collet comprising: a collet head including a plurality of elements suitable to hold a tool or workpiece; a pull screw having a head in tangential cooperative relationship with said collet head elements; means to move said pull screw in such manner as to cause expansion of said collet head elements with relation to each other; means cooperative with said pull screw to prevent excessive expansion of the collet head elements; tension means cooperative with said pull screw to move the pull screw away from contact with the collet head elements; and at least one set of elliptically shaped male and female mating elements.

10. A collet comprising: a collet head including a plurality of elements suitable to hold a tool or workpiece; a pull screw having a head in tangential cooperative relationship with said collet head elements; means to move said pull screw in such manner as to cause expansion of said collet head elements with relation to each other; means cooperative with said pull screw to prevent excessive expansion of the collet head elements; tension means cooperative with said pull screw to move the pull screw away from contact with the collet head elements; and at least one set of shaped male and female mating elements with mating dowel and keyway alignment means.

11. The improvement in an external collet comprising an external bearing surface used for closing the collet at a thirty degree angular relationship to the collet axis.
